(19) United States
(12) Patent Application Publication
(10) Pub. No.: US 2024/0381293 A1
(43) Pub. Date: Nov. 14, 2024

(54) METHOD AND APPARATUS FOR ULTRA-WIDEBAND (UWB) COMMUNICATION AND NARROW BAND (NB) COMMUNICATION

(71) Applicant: Samsung Electronics Co., Ltd., Suwon-si (KR)

(72) Inventors: Mingyu LEE, Suwon-si (KR); Taeyoung HA, Suwon-si (KR); Youngwan SO, Suwon-si (KR)

(21) Appl. No.: 18/660,709

(22) Filed: May 10, 2024

(30) Foreign Application Priority Data
May 12, 2023 (KR) 10-2023-0062017

(51) Int. Cl. H04W 64/00; H04W 4/12

(52) U.S. Cl. CPC H04W 64/00; H04W 4/12

(57) ABSTRACT

A method for managing both an ultra-wideband (UWB) channel and a narrow band (NB) channel is provided. The method performed by a first UWB device includes receiving an advertisement response (Adv RESP) message responding to an advertisement poll (Adv Poll) message from a second UWB device through the NB channel, transmitting a start of ranging (SoR) message corresponding to the Adv RESP message to the second UWB device through the NB channel, performing, based on the SoR message, UWB ranging with the second UWB device, and transmitting a ranging packet report (RPRT) message to the second UWB device, through one of the NB channel and the UWB channel.

### CROSS-REFERENCE TO RELATED APPLICATION(S)

This application is based on and claims priority under 35 U.S.C. § 119(a) of a Korean patent application number 10-2023-0062017, filed on May 12, 2023, in the Korean Intellectual Property Office, the disclosure of which is incorporated by reference herein in its entirety.

### BACKGROUND

### 1. Field

The disclosure relates to ultra-wideband (UWB) communication. More particularly, the disclosure relates to a method and an apparatus for providing a UWB service through a UWB channel and a narrow band (NB) channel.

### 2. Description of Related Art

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

With the advance of wireless communication systems as described above, various services can be provided, and accordingly there is a need for ways to effectively provide these services. For example, a ranging technology for measuring the distance between electronic devices by using an ultra wide band may be used.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for providing a ultra-wideband (UWB) service through a UWB channel and a narrow band (NB) channel.

Additional aspects will be set forth in part in the description which follows and, in part, will be apparent from the description, or may be learned by practice of the presented embodiments.

In accordance with an aspect of the disclosure, a method performed by a first UWB device is provided. The method includes receiving an advertisement response (Adv RESP) message responding to an advertisement poll (Adv Poll) message from a second UWB device through an NB channel, transmitting a start of ranging (SoR) message corresponding to the Adv RESP to the second UWB device through the NB channel, performing, based on the SoR, UWB ranging with the second UWB device, and transmitting a ranging packet report (RPRT) message to the second UWB device, wherein the RPRT message is transmitted through one of the NB channel and a UWB channel.

In accordance with another aspect of the disclosure, a method performed by a second UWB device is provided. The method includes transmitting an Adv RESP message responding to an Adv Poll message to a first UWB device through an NB channel, receiving an SoR message corresponding to the Adv RESP message from the first UWB device through the NB channel, performing, based on the SoR, UWB ranging with the first UWB device, and transmitting an RPRT message to the first UWB device, wherein the RPRT message is transmitted through one of the NB channel and a UWB channel.

In accordance with another aspect of the disclosure, a first UWB device is provided. The first UWB includes a transceiver, memory storing one or more computer programs, and at least one processor communicatively coupled to the transceiver and the memory, wherein the one or more computer programs include computer-executable instructions that, when executed by the at least one processor, cause the first UWB device to receive an Adv RESP message responding to an Adv Poll message from a second UWB device through an NB channel, transmit an SoR message corresponding to the Adv RESP message to the second UWB device through the NB channel, perform, based on the SoR message, UWB ranging with the second UWB device, and transmit an RPRT message to the second UWB device, and the RPRT is transmitted through one of the NB channel and a UWB channel.

In accordance with another aspect of the disclosure, a second UWB is provided. The second UWB includes a transceiver, memory storing one or more computer programs, and at least one processor communicatively coupled to the transceiver and the memory, wherein the one or more computer programs include computer-executable instructions that, when executed by the at least one processor, cause the second UWB device to transmit an Adv RESP message responding to an Adv Poll message to a first UWB device through an NB channel, receive an SoR message corresponding to the Adv RESP message from the first UWB deice through the NB channel, perform, based on the SoR message, UWB ranging with the first UWB device, and transmit an RPRT message to the first UWB device, and the RPRT message is transmitted through one of the NB channel and a UWB channel.

Another aspect of the disclosure is to provide a method for efficiently performing measurement reporting between electronic devices by managing a UWB channel and an NB channel.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is illustrative architecture of a UWB device according to an embodiment of the disclosure;

FIG. 1B illustrates a communication system including a UWB device according to an embodiment of the disclosure;

FIG. 2 illustrates a method for performing an NB procedure and a UWB procedure by a UWB device according to an embodiment of the disclosure;

FIG. 3 illustrates an example of a structure of a round and a ranging block used for UWB ranging according to an embodiment of the disclosure;

FIG. 4 illustrates a UWB ranging operation according to an embodiment of the disclosure;

FIG. 5 illustrates an operation of a UWB device in a ranging area network according to an embodiment of the disclosure;

FIG. 6A illustrates a multi-millisecond (MMS) UWB ranging operation according to an embodiment of the disclosure;

FIG. 6B illustrates an operation of performing communication using an NB channel and a UWB channel according to an embodiment of the disclosure;

FIG. 7A is a view illustrating an MMS UWB ranging operation according to an embodiment of the disclosure;

FIG. 7B illustrates the number of UWB packets based on a channel state according to an embodiment of the disclosure;

FIG. 8A illustrates a frame format of a poll, response, report message according to an embodiment of the disclosure;

FIG. 8B is a view illustrating a transmission length of a poll, response, and report message according to an embodiment of the disclosure;

FIG. 9A illustrates an example of a frame format of a response or report message according to an embodiment of the disclosure;

FIG. 9B illustrates a signal ranging distance based on a link budget of a data transmission speed according to an embodiment of the disclosure;

FIG. 10 is a view illustrating operations in an initialization channel and a ranging channel according to an embodiment of the disclosure;

FIG. 11 illustrates an example of a field included in an advertisement response message (or a start of ranging (SoR) message) according to an embodiment of the disclosure;

FIG. 12 illustrates an example of a field including an advertisement response message (or a start of ranging (SoR) message) according to an embodiment of the disclosure;

FIG. 13 illustrates an example of a field included in an advertisement response message (or a start of ranging (SoR) message) according to an embodiment of the disclosure;

FIG. 14 is a flow chart illustrating an operation of a UWB device according to an embodiment of the disclosure;

FIG. 15 a flow chart illustrating an operation of a UWB device according to an embodiment of the disclosure; and

FIG. 16 illustrates a UWB device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, according to some embodiments, the “unit” may include one or more processors.

As used herein, the term “terminal” or “device’ may be called a mobile station (MS), a user equipment (UE), a user terminal (UT), a wireless terminal, an access terminal (AT), a terminal, a subscriber unit (SU), a subscriber station (SS), a wireless device, a wireless communication device, a wireless transmit/receive unit (WTRU), a mobile node, a mobile, or any other term. Various example of the terminal may include a cellular phone, a smartphone having a wireless communication function, a personal digital assistant (PDA) having a wireless communication function, a wireless modem, a portable computer having a wireless communication function, a photographing device, such as a digital camera, having a wireless communication function, a gaming device having a wireless communication function, a music storage and reproduction home appliance having a wireless communication function, an Internet home appliance capable of wireless Internet access and browsing, and portable units or terminals having integrated combinations of the above functions. Furthermore, the terminal may include a machine to machine (M2M) terminal, and a machine type communication (MTC) terminal/device, but is not limited thereto. In the specification, the terminal may also be simply called an electronic device or a device.

Hereinafter, the operation principle of the disclosure will be described in detail with reference to the accompanying drawings. In the following description of the disclosure, detailed descriptions of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using UWB will be described by way of example, but the embodiments of the disclosure may be applied to other communication systems having similar technical backgrounds or characteristics. Examples thereof may include communication systems using Bluetooth or Zigbee. Therefore, based on determinations by those skilled in the art, the embodiments of the disclosure may be applied to other communication systems through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technology is largely divided into a wireless local area network (WLAN) technology and a wireless personal area network (WPAN) according to a recognition distance. In this case, the wireless LAN is a technology based on IEEE 802.11, and is a technology enabling access to a backbone network within the radio of about 100 m. In addition, the wireless personal area network is a technology based on IEEE 802.15, and includes Bluetooth, ZigBee, ultra-wideband (UWB), etc. A wireless network in which such wireless network technology is implemented may include multiple electronic devices. The UWB may mean a band itself to which UWB communication is applied. The UWB enables secure and accurate ranging between devices. Accordingly, the UWB enables relative positioning based on the distance between two devices or accurate device positioning based on the distance from fixed devices (the locations of which are known).

Specific terms used in the description below are provided to assist understanding of the disclosure, and use of such specific terms may be changed into other forms without departing from the scope of the technical idea of the disclosure.

A “ranging device” may be a device capable of performing UWB device. In the disclosure, the ranging device may be, for example, a ranging device (RDEV) or an enhanced ranging device (ERDEV) defined in IEEE 802.15.4/4z. In the disclosure, the ranging device may be referred to as a ranging device, a UWB device, UWB device E.

An “advertiser” may be a device (e.g., ranging device) for transmitting a message for discovery. For example, the advertiser may be a device for transmitting (or broadcasting) an advertisement message through an initialization channel.

A “scanner” may be a device (e.g., ranging device) for receiving a message for discovery. For example, the scanner may scan the initialization channel to receive the advertisement message.

A “controller” may be a device (e.g., ranging device) for defining and controlling a ranging control message (RCM) (or a control message).

A “controlee” may be a device (e.g., ranging device) using a ranging parameter within the RCM (or control message) received from the controller.

An “initiator” may be a device (e.g., ranging device) for initiating ranging exchange.

A “responder” may be a device (e.g., ranging device) responding to the initiator in the ranging exchange.

“In-band” is an underlying wireless technology, and may be data communication using UWB.

“Out-of-band (OBB)” is an underlying wireless technology, and may be data communication not using UWB.

A “UWB session” may be a duration from a start of communication to suspension of communication between the controller and the controlee through UWB. In the UWB session, a ranging frame (RFRAME) may be transferred, a data frame may be transferred, or both the ranging frame and the data frame may be transferred.

A “UWB session ID” may be an ID (e.g., a 32-bit integer) which is shared between the controller and the controlee and identifies the UWB session

A “UWB session key” may be a key used for protecting the UWB session. The UWB session key may be used to generate a scrambled timestamp sequence (STS). In the disclosure, the UWB session key may be a UWB ranging session key (URSK), or may be simply referred to as a session key.

A “UWB subsystem (UWBS)” may be a hardware component for implementing UWB physical (PHY) and medium access control (MAC) specs included in the UWB device. In the disclosure, the UWB PHY and MAC specs may be PHY and MAC specs defined in IEEE 802.15.4/4z. In the disclosure, the UWBS may be referred to as a UWB component.

A “UWB-enabled application” may be an application for service (UWB service). In the disclosure, the “UWB-enabled application” may be simply referred to as an application or a UWB application.

A “service” may be implementation of a user case of providing an end user with the service. In the disclosure, the service may be referred to as a UWB service.

“Service data” may be data defined by a service provider and required to be transferred between two ranging devices to implement the service.

A “service provider” may be an entity for defining and providing hardware and software required to provide a specific service to an end user.

A “UWB channel” may be one of candidate UWB channels allocated for UWB communication. The candidate UWB channels allocated for UWB communication may be channels allocated for UWB communication. The UWB channel may be used for UWB communication (e.g., UWB ranging and/or transaction).

A “narrow band (NB) channel” may be a channel having a narrower bandwidth than the UWB channel. In an embodiment, the NB channel may be one sub channel from the candidate UWB channels allocated for UWB communication, or may be a channel using a specific bandwidth of another available band (e.g., a part of an industrial, scientific, and medical (ISM) band, etc.). The candidate channels allocated for UWB communication may be channels allocated for UWB communication. The NB channel may be used for connection configuration for advertising, device discovery, and/or additional parameter negotiation/authentication. For example, the NB channel may be used for transmission or reception of a discovery beacon (message), an advertisement message, an additional advertising message, a connection request message, and/or a connection acknowledgement message. In an embodiment, one or multiple NB channels may be managed together. In an embodiment, the NB channel may be used for in-band communication, similar to the UWB channel.

In addition, in describing the disclosure, if it is determined that a specific description of a related known function and configuration may unnecessarily obscure the gist of the disclosure, a detailed description thereof will be omitted.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, various embodiments of the disclosure are described with reference to the accompanying drawings.

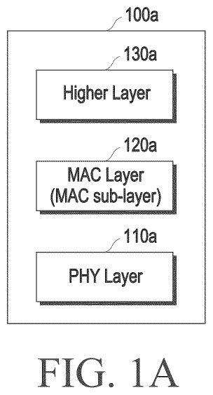

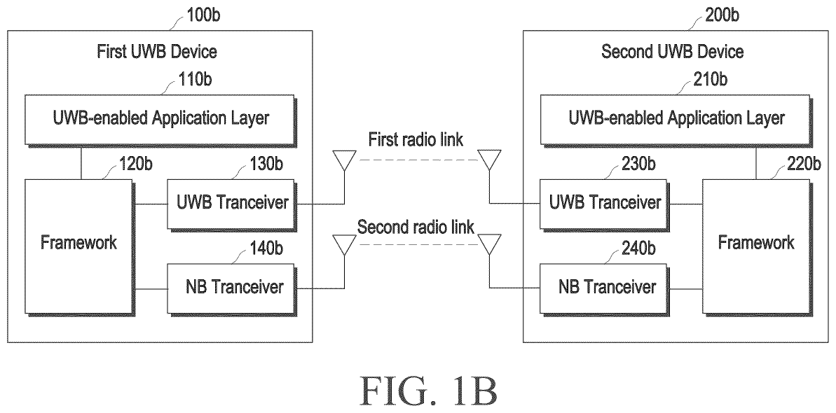

FIG. 1A is illustrative architecture of a UWB device according to an embodiment of the disclosure.

Referring to FIG. 1A, a UWB device 100a may include at least one PHY layer 110a, a MAC layer (MAC sub-layer) 120a, and/or a higher layer 130a.

### (1) PHY Layer

The at least one PHY layer 110a may include a low-level control mechanism and a transceiver. In the disclosure, the transceiver may be referred to as an RF transceiver or a radio transceiver.

In an embodiment, the at least one PHY layer 110a may include at least one first transceiver for supporting a UWB channel, and at least one second transceiver for supporting an NB channel having a narrower bandwidth than the UWB channel. In the disclosure, the first transceiver may be referred to as a UWB transceiver, and the second transceiver may be referred to as an NB transceiver.

In another embodiment, the at least one PHY layer 11a may include a transceiver (a dual channel transceiver) for supporting both the UWB channel and the NB channel.

In an embodiment, the PHY layer 110a may support at least one of the following functions.
Activation and deactivation function of transceiver (transceiver on/off function)
Energy detection function
Chanel selection function
Clear channel assessment (CCA) function
Synchronization function
low-level signaling function
UWB ranging, positioning, and localization function
Spectrum resource management function
Function of transmitting/receiving packet through physical medium

### (2) MAC Layer

The MAC layer 120a provides an interface between the higher layer 130a and the PHY layer 120a.

In an embodiment, the MAC layer 120a may provide the following two services.
MAC data service: Service enabling transmission or reception of a MAC protocol data unit (PDU) through PHY
MAC management service: Service for interfacing MAC sublayer management entity (MLME) service access point (SAP) (MLME-SAP)

In an embodiment, the MAC layer 120a may support at least one of the following functions.
Device discovery and connection configuration function
Channel access function (function of accessing physical channel (e.g., NB channel/UWB channel))
Synchronization function (e.g., synchronization of NB channel (mirroring channel) and UWB channel)
Interference mitigation function based on energy detection
Function related to narrowband signaling
Guaranteed timeslot (GTS) management function
Frame delivery function
UWB ranging function
PHY parameter change notification function
Security function

### (3) Higher Layer

The higher layer 130a may include a network layer for providing a function such as network configuration and message routing, and/or an application layer for providing an intended function of a device.

In an embodiment, the application layer may be a UWB-enabled application layer for providing a UWB service.

FIG. 1B illustrates a communication system including a UWB device according to an embodiment of the disclosure.

Referring to FIG. 1B, a communication system 10b may include a first UWB device 100b and a second UWB device 200b. For example, the first UWB device 100b and/or the second UWB device 200b of FIG. 1B may be an example of the UWB device 100a of FIG. 1A.

The first UWB device 100b may include a UWB-enabled application layer 110b, a framework 120b, at least one UWB transceiver 130b, and/or at least one NB transceiver 140b. In addition, the second UWB device 200b may include a UWB-enabled application layer 210b, a framework 220b, at least one UWB transceiver 230b, and/or at least one NB transceiver 240b.

Referring to FIG. 1B, the UWB transceiver and the NB transceiver of each device are illustrated as separate elements, but the elements are divided according to the operations/functions thereof. That is, this is not intended to limit that the UWB transceiver and the NB transceiver are implemented as separate physical elements (e.g., separate chipsets). Accordingly, the UWB transceiver and the NB transceiver may be implemented as separate chipsets, respectively, and the UWB transceiver and the NB transceiver may be implemented as one integrated chipset.

The UWB-enabled application layer 110b or 210b may be a higher application layer for a UWB service.

The framework 120b or 220b may be an entity for integrating the UWB transceiver 130b or 230b and the NB transceiver 140b or 240b and managing the same. In an embodiment, the framework 120b or 220b may support a function of controlling UWB/NB communication (e.g., medium access control (MAC), UWB/NB transceiver synchronization function) and/or a function of communicating acquired information with the higher application layer 110b or 210b.

The UWB transceiver 130b or 230b may support at least one of candidate UWB channels for UWB communication. That is, the UWB transceiver 130b or 230 may support at least UWB channel. The UWB transceiver 130b or 230b or at least one UWB channel supported by the UWB transceiver 130b or 230b may be used for UWB communication (e.g., UWB ranging and/or transaction). For example, the UWB transceiver 130b or 230b and at least one UWB channel supported by the UWB transceiver 130b or 230b may be used for transmission/reception of a data frame and/or a ranging frame (RFRAME).

The NB transceiver 140b or 240b may support at least one NB channel having a narrower bandwidth (e.g., 50 MHz or lower) than the UWB channel. The NB transceiver 140b or 240b or at least one NB channel supported by the NB transceiver 140b or 240b may be used for advertisement (discovery) and/or narrowband signaling.

In an embodiment, the NB channel may be one sub channel among candidate UWB channels allocated for UWB communication. In another embodiment, the NB channel may be a channel using a specific bandwidth of other available bandwidths (e.g., a part of an industrial, scientific, and medical (ISM) band, etc.).

In an embodiment, the NB channel may be used for in-band communication, like the UWB channel.

The NB channel has a narrower bandwidth than the UWB channel.

However, the band of the NB channel may be identical to or different from the band of the UWB channel. For example, the NB channel and the UWB channel may use different bands. For example, a channel number (or a band group number) of a candidate UWB channel including sub channels allocated to the NB channel may be different from a channel number (or a band group number) of a candidate UWB channel allocated to the UWB channel. In another example, the NB channel and the UWB channel may use the same band. For example, a channel number (or a band group number) of a candidate UWB channel including sub channels allocated to the NB channel may be identical to a channel number (or a band group number) of a candidate UWB channel allocated to the UWB channel.

In an embodiment, the first UWB device 100b and the second UWB device 200b may perform UWB communication (procedure) (in-band communication) through a first radio link (UWB channel) configured through the UWB transceiver 130b of the first UWB device 100b and the UWB transceiver 230b of the second UWB device 200b.

In an embodiment, the first UWB device 100b and the second UWB device 200b may perform NB communication (procedure) (in-band communication) through a second radio link (NB channel) configured through the NB transceiver 140b of the first UWB device 100b and the NB transceiver 240b of the second UWB device 200b.

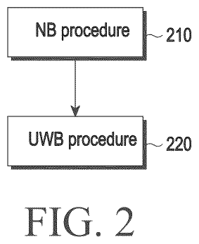

FIG. 2 illustrates a method for performing an NB procedure and a UWB procedure by a UWB device according to an embodiment of the disclosure.

The UWB device of FIG. 2 may be, for example, the UWB device of FIG. 1A or FIG. 1B.

Referring to FIG. 2, the UWB device may perform an NB procedure 210 and a UWB procedure 220. The NB procedure 210 and the UWB procedure 220 may be managed or controlled by a MAC layer (entity) of the UWB device.

### (1) NB Procedure 210

In the disclosure, the NB procedure 210 means a procedure performed using at least one NB channel. The NB procedure 210 may be performed before the UWB procedure 220.

The NB procedure 210 may include at least one of the following operations.
Operation of transmitting and/or receiving advertisement message through at least one NB channel by UWB device (advertising operation)
Operation of transmitting and/or receiving discovery beacon (message) through at least one discovery channel by UWB device (discovery operation)

### (2) UWB Procedure 220

In the disclosure, the UWB procedure 220 means a procedure performed using at least one UWB channel.

The UWB procedure 220 may include at least one of the following operations.
Operation of performing UWB ranging with another UWB device by UWB device (UWB ranging operation)
Operation of exchanging service data with another UWB device by UWB device

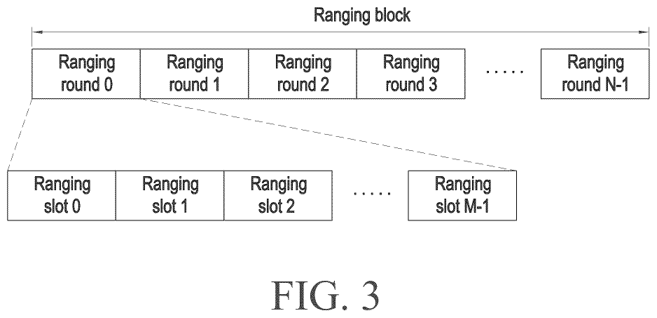

FIG. 3 illustrates an example of a structure of a round and a ranging block used for UWB ranging according to an embodiment of the disclosure.

In the disclosure, a ranging block refers to a time period for ranging. A ranging round may be a period of sufficient duration for completing an entire range-measurement cycle involving a set of UWB devices participating in ranging exchange. A ranging slot may be a period of sufficient duration for transmission of at least one ranging frame (RFRAME) (e.g., ranging starting/responding/final message, etc.).

Referring to FIG. 3, one ranging block may include at least one ranging round, and each ranging round may include at least one raining slot.

When a ranging mode is a block-based mode, a mean time between consecutive ranging rounds may be a constant. Alternatively, when the ranging mode is an interval-based mode, a time between consecutive ranging rounds may be dynamically changed. That is, the interval-based mode may adapt a time structure having an adaptive spacing.

The durations and the number of slots included in the ranging round may be changed between ranging rounds. This may be configured through a control message of a controller.

In the disclosure, the ranging block may be simply referred to by a block, the ranging round may be simply referred to by a round, and the ranging slot may be simply referred to by a slot.

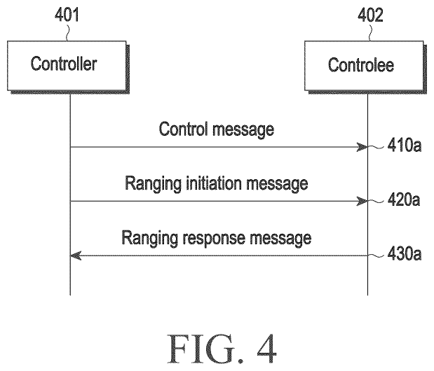

FIG. 4 illustrates a UWB ranging operation according to an embodiment of the disclosure.

The UWB ranging operation of FIG. 4 may be an example of the UWB ranging operation of the UWB procedure of FIG. 2. The UWB ranging operation of FIG. 4 may be performed through a UWB channel.

In an embodiment of FIG. 4, the UWB ranging may be, for example, single-sided two-way ranging (SS-TWR) or double-sided two-way ranging (DS-TWR).

In an embodiment of FIG. 4, it is assumed that a controller 401 performs the role of an initiator and a controlee 402 performs the role of a responder.

Referring to operation 410a, the controller 401 may transmit a control message (ranging control message) for controlling UWB ranging to the controlee 402. For example, the controller 401 may transmit the control message to the controlee 402 through the UWB channel. In an embodiment, the control message may include information on the rule (e.g., initiator or responder) of the UWB device, ranging slot index information, and/or address information of the UWB device.

Referring to operation 420a, the controller (initiator) 401 may transmit a ranging initiation message for initiating ranging exchange to the controlee (responder) 402. For example, the controller (initiator) 401 may transmit the ranging initiation message to the controlee (responder) 402 through the UWB channel.

Referring to operation 430a, the controlee (responder) 402 may transmit a ranging response message corresponding to the ranging initiation message to the controller (initiator) 401. For example, the controlee (responder) 402 may transmit the ranging response message to the controller (initiator) 403 through a UWB channel.

In an embodiment, the ranging response message may further include measurement report information. The measurement report information may include, for example, AoA measurement, a relay time measured by the responder, and a list of round-trip time measurements for responders and responder addresses. Here, the relay time may indicate a difference between a reception time of the ranging initiation message and a transmission time of the ranging response message at the responder side. Based thereon, the singe-sided two-way ranging (SS-TWR) may be performed. The calculation of a time-of-flight (ToF) and distance/direction/location through the SS-TWR follows a scheme defined in IEEE 802.15.4z.

In a case of DS-TWR, the controller (initiator) 401 may further transmit a ranging final message (ranging response message) for completing the ranging to the controlee (responder) 402. For example, the controller (initiator) 401 may further transmit the ranging final message to the controlee (responder) 402 through a UWB channel.

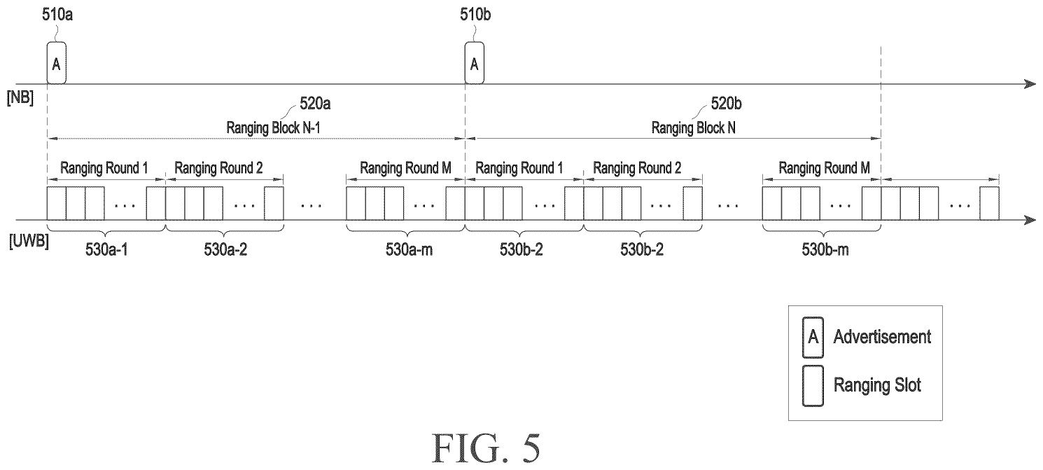

FIG. 5 illustrates a structure of a channel used in a ranging area network according to an embodiment of the disclosure.

In the disclosure, a ranging area network (RAN) may be a network including multiple UWB devices performing UWB ranging. The ranging area network may be referred to as a new generation (NG) ranging area network (RAN), and the UWB device may be referred to as an NB UWB device.

In an embodiment of FIG. 5, a ranging block, a ranging round, and a ranging slot transmitted through the UWB channel may be a ranging block, a ranging round, and a ranging slot used in a session (e.g., UWB ranging session) pre-configured by a UWB device (e.g., a first UWB device of FIG. 1B) for performing the role of an advertiser/controller.

Referring to FIG. 5, an NB channel and a UWB channel may be used in the ranging area network.

In an embodiment, the NB channel may be used to transmit and/or receive at least one advertisement message. For example, the NB channel may be used to transmit or receive a first advertisement message 510a and a second advertisement message 510b.

In an embodiment, the UWB channel may be used to transmit and/or receive at least one ranging message for UWB ranging. The at least one ranging message may be transmitted/received through ranging blocks 520a and 520b.

As described in FIG. 3, each ranging block may include at least one ranging round, and each ranging round may include at least one ranging slot. For example, a first ranging block 520a may include M ranging rounds 530a-1, 530a-2, . . . , and 530a-m, and each of the ranging round may include multiple ranging slots. In addition, a second ranging block 520b may include M ranging rounds 530b-1, 530b-2, . . . , and 530b-m, and each of the ranging rounds may include multiple ranging slots.

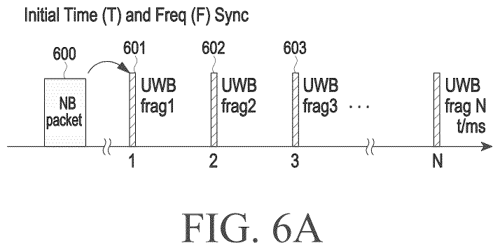

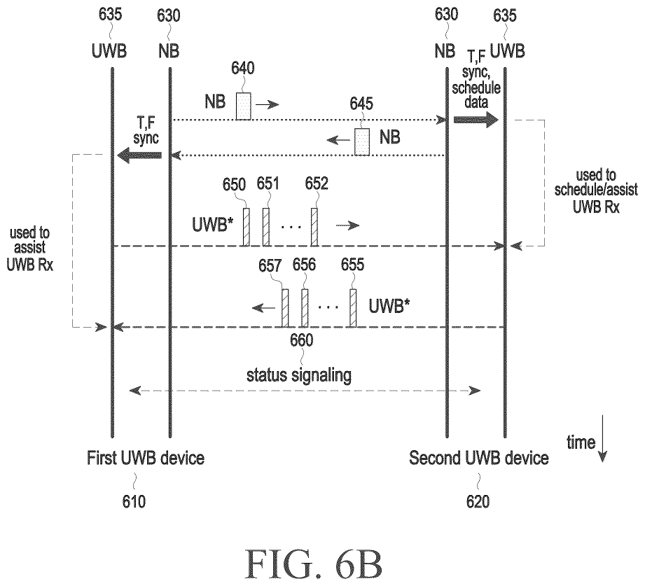

FIG. 6A illustrates a multi-millisecond (MMS) UWB ranging operation according to an embodiment of the disclosure.

To improve the accuracy of a time of flight (ToF) and a link budget, MMS UWB may be a mode defined in IEEE 802.15.4ab, in which multiple fragments/packets are transmitted at regular intervals (e.g., 0.5 ms, 1 ms, etc.) through UWB.

A “link budget” means a total sum of loss factors and power required for data transmission between a transmitter and a receiver. The link budget refers to a value in consideration of all losses and gains generated until a transmission signal is received in the receiver after being transmitted. The link budget may be calculated in consideration of transmission power, reception sensitivity, a transmission distance, a transmission medium (air, obstacle, etc.), an antenna gain, a loss factor, etc. In the UWB system, an appropriate antenna, transmission power, receiver, and transmitter may be selected in consideration of the link budget, and thus the performance can be enhanced.

Here, the transmission interval of the multiple fragments/packets is not limited to a specific length. For example, each fragment (or a UWB packet including each fragment) may be multi-transmitted through the UWB in an interval of 1 ms. Such multiple fragments/packets may be used for UWB ranging (e.g., SS-TWR, DS-TWR, etc.). The UWB system needs to comply with maximum transmission power defined in the regulatory authority to prevent unnecessary interference from being generated in other wireless systems. For example, in the UWB system, to comply with maximum transmission power, a transmittable data length per transmission may need to comply with 1 ms. In this case, when a packet length is increased due to increase of data, there is problem that transmission power per one pulse is reduced to comply with the maximum transmission power. Accordingly, reduction in transmission power per one pulse due to shortage of the data length can be prevented by dividing a packet and transmitting the same through utilization of MMS UWB communication. For example, the data length may be maintained within 1 ms to transmit a UWB packet at maximum transmission power.

Referring to FIG. 6A, a first UWB device may transmit an NB packet 600 to a second UWB device through an NB channel and multiple UWB fragments 601, 602, 603, . . . to the second UWB device through a UWB channel. The NB packet 600 may provide initial time and frequency synchronization for the UWB fragments 601, 602, 603, . . . so that the UWB device is coupled to several 1-ms fragments, whereby the link budget can be enhanced. In addition, the NB packet 600 may transfer transmission start point and period information of the UWB fragments 601, 602, 603, . . . and perform data offloading, thereby minimizing a UWB packet length.

FIG. 6B illustrates an operation of performing communication using an NB channel and a UWB channel according to an embodiment of the disclosure.

Referring to FIG. 6B, a first UWB device 610 and a second UWB device 620 may transmit/receive NB packets 640 and 645 through an NB channel 630. Thereafter, the first UWB device 610 and the second UWB device 620 may transmit/receive multiple UWB fragments/packets 650, 651, 652, 655, 656, 657, . . . through a UWB channel 635 time/frequency synchronized by the NB packets 640 and 645. In this case, reception of the multiple UWB fragments/packets 650, 651, 652, 655, 656, 657, . . . in the UWB channel may be scheduled by the NB packets 640 and 645. Thereafter, the first UWB device 610 and the second UWB device 620 may perform status signaling 660 therebetween.

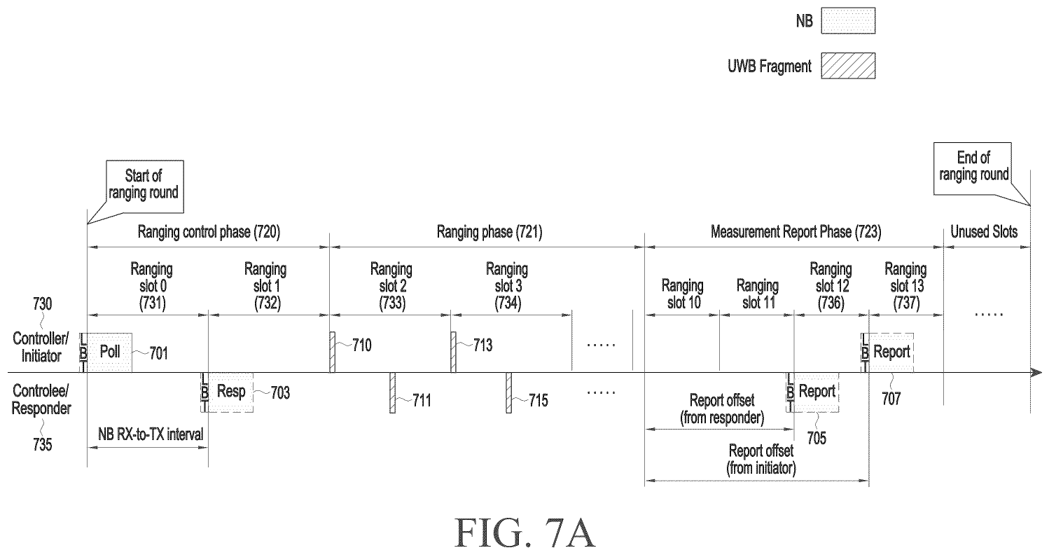

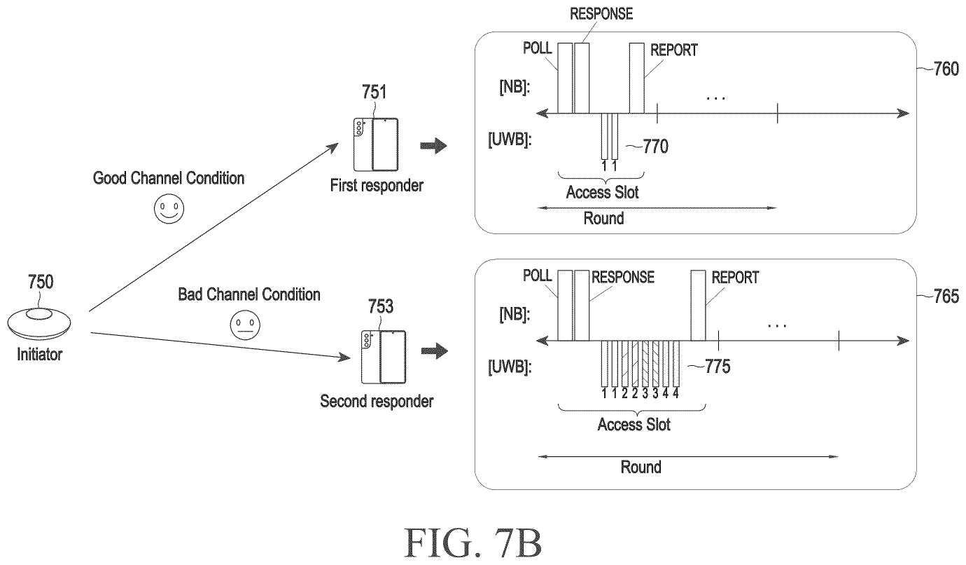

FIG. 7A is a view illustrating an MMS UWB ranging operation according to an embodiment of the disclosure.

In a UWB ranging operation, a code only frame format (or a ranging sequence frame) is defined, and a link budget can be enhanced at a reception side through multiple transmissions.

Referring to FIG. 7A, a controller (initiator) 730 may transmit a poll packet 701 to a controlee (responder) 735 through an NB channel in ranging slot 0 (731) of a ranging control phase 720. The controlee (responder) 735 may transmit a response (resp) packet 703 to the controller (initiator) 730 in ranging slot 1 (732) of the ranging control phase 720. Thereafter, when the ranging phase 721 is initiated, the controller (initiator) 730 and the controlee (responder) 735 may transmit or receive UWB fragments 710, 711, 713, 715, . . . ) through the UWB channel in ranging slots 2 and 3 (733 and 734). In this case, when one UWB packet is divided into multiple UWB fragments and transmitted several times, the link budget is enhanced in proportion to the number of fragments. Accordingly, the controller (initiator) 730 and the controlee (responder) 735 may divide one UWB packet into UWB fragments 710. 713, . . . and transmit the same several times, thereby enhancing the link budget and transmission reliability.

The controlee (responder) 735 may transmit a report packet 705 to the controller (initiator) 730 in ranging slot 12 (736) after a report offset in a measurement report phase 723. The controller (initiator) 730 may transmit a report packet 707 to the controlee (responder) 735 through an NB channel in ranging slot 13 (737) after a report offset in the measurement report phase 723.

FIG. 7B illustrates the number of UWB fragments determined based on a channel state according to an embodiment of the disclosure.

Referring to FIG. 7B, an initiator 750, a first responder 751, and a second responder 753 may determine, based on a target link budget, the number of UWB fragments according to a channel state. In an embodiment, the target link budget is low when a channel state between the initiator 750 and the first responder 751 is relatively good 760, and thus it may be determined that a UWB fragment 770 is transmitted one time. In another embodiment, the target link budget is large when a channel state between the initiator 750 and the second responder 753 is not relatively good 765, it may be determined that the UWB fragment 775 is transmitted multiple times.

In an embodiment, when the initiator and responder transmit or receive the poll packet and the response packet in the NB channel, the number of UWB fragments may be determined through measurement of transmission and reception signal power strengths and comparison with a pre-configured threshold.

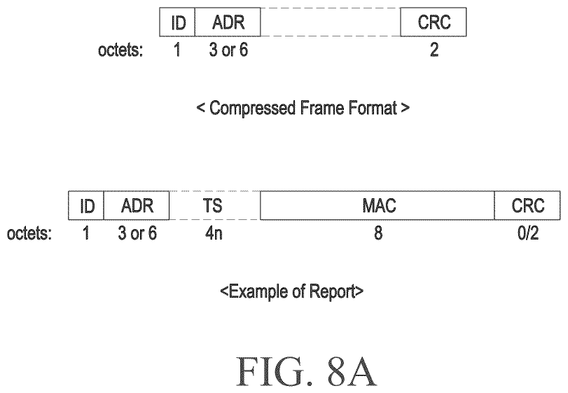

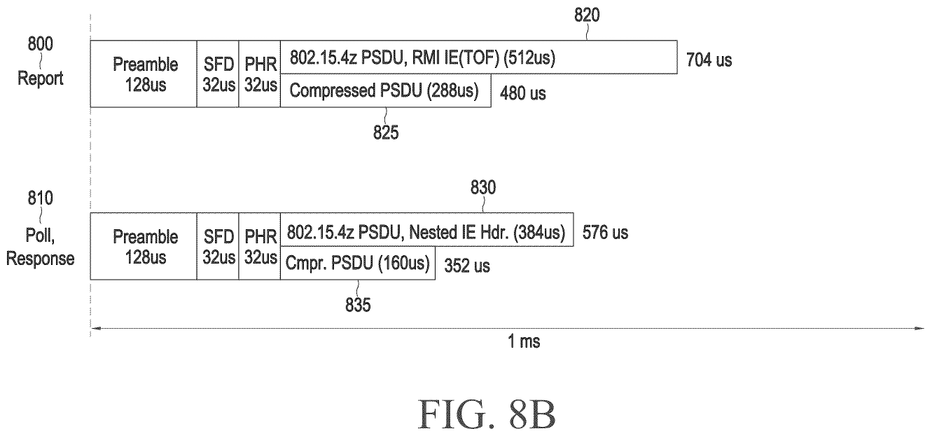

FIG. 8A illustrates a frame format of an NB poll, response, report message according to an embodiment of the disclosure.

Referring to FIG. 8A, data is described in units of octets, and an octets refers to a minimum unit for representing data in 8 bits.

In an embodiment, a compressed frame format may include the following structures.
1-octet message ID (OxOO=Poll, 0x01=Response, 0x02=Report,
3 or 6-octet session identifier/address
ID specific data (variable length)
2-octet CRC16

In an embodiment, a frame format of an NB report may include the following structures.
1-octet message ID (Oxtbd)
3 or 6-octet session identifier/address
4-octet timestamp(s) (encrypted)
8-octet cryptographic protection (MAC)

The cryptographic protection (MAC) is not an essential field in the frame format of the NB report, and may be omitted.

In a case of the NB report, the number of time stamps varies according to the number of electronic devices, and a total data length may be 15, 19, and 23 octets if there is no CRC, and may be 17, 21, and 25 octets if a CRC is included.

The length of a PHR field in the frame format may be determined according to the number of time stamps (TS) and a sum of CRCs. Accordingly, in the compressed frame format, a physical service data unit (PSDU) size may be reduced by utilizing redundancy between ENC-MIC-64 and CRC16.

FIG. 8B is a view illustrating a transmission length of a poll, response, and report message according to an embodiment of the disclosure.

FIG. 8B illustrates a data transmission length when data is transmitted at the speed of 250 kbps.

Referring to FIG. 8B, in an embodiment, the length 820 of a report message 800 may be 704 μs when including preamble, start frame delimiter (SFD), PHY header (PHR) fields, a PSDU defined in IEEE 802.15.4z, and an RMI IE (TOF). On the other hand, the length 825 of the report message 800 may be 480 μs when including a compressed physical service data unit (PSDU) with reference to one time stamp.

In an embodiment, the length 830 of the poll and response message 810 may be 576 μs when including preamble, SFD, and PHR fields, a PSDU defined in IEEE 802.15.4z, and a nested information element (IE). On the other hand, the length 835 of the poll and response message 810 may be 352 μs when including a compressed PSDU.

That is, the transmission length of the NB poll, response, and report message at the speed of 250 kbps is within 1 ms, and transmission is possible within one ranging slot implemented as 1 ms in a UWB device in most cases.

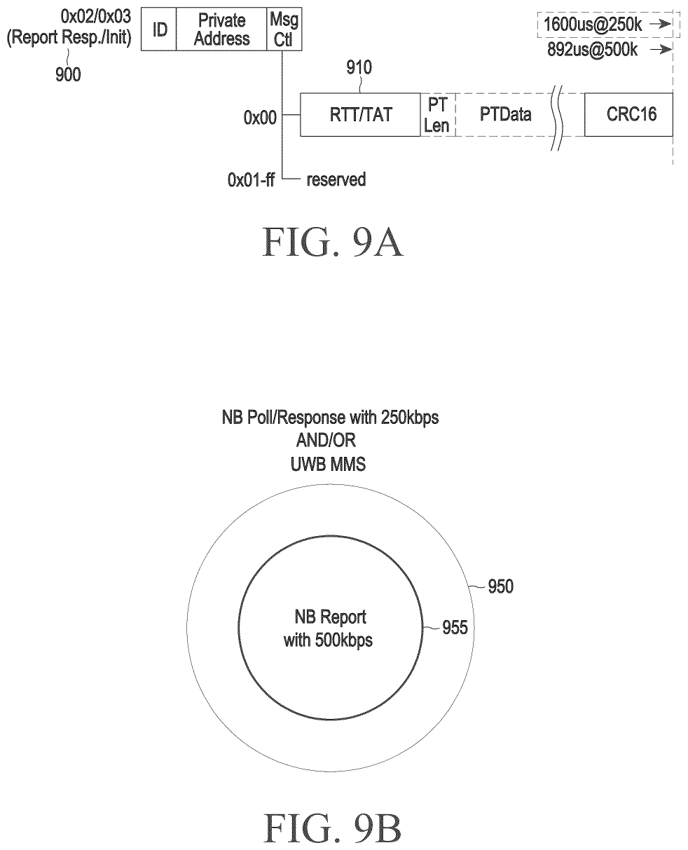

FIG. 9A illustrates an example of a frame format of a report message according to an embodiment of the disclosure.

FIG. 9A illustrates an example of a maximum 44-byte transmission length of a report message including a maximum of a PSDU. The report message includes report messages of a responder and an initiator. In the disclosure, a report after UWB ranging may refer to ranging packet report (RPRT), and the terms “report” and “RPRT” may be interchangeably used.

Compared to FIG. 8A, FIG. 9A illustrates a case where not only a time stamp but also pass-through (PT) data is added. PT data means user-defined data rather than data basically transmitted in the UWB system. When a maximum of four time stamps are used and PT data is included, a frame format 900 of the report frame may include the following structure.
1-octet message ID (0x02: RPRT Responder, 0x03: RPRT Initiator)
3-octet private session address (PrivateSalt known from POLL)
1-octed message control, setting the following message content

0x00: MessageContent=Timestamp[4]+PTLen[1]+PTData[PTLen]
2-octet CRC16

Referring to FIG. 9A, a time stamp 910 may include a round trip time (RTT) or a turnaround time (TAT) at each 1/128/499.2 MHz resolution.

Referring to FIG. 9A, when the report message further includes PTLen and PTData, at the transmission speed of 250 kbps, a data length is 1,600 μs, which exceeds 1 ms. Such report message exceeds the length of a ranging slot, which is generally implemented as 1 ms, is transmitted using multiple ranging slots, and is thus not recommended in the UWB system. Accordingly, when the report message in the case of further including the PT data is transmitted at 500 kbps, the data length is 892 μs, which is within 1 ms, and thus a method for increasing a data transmission speed when transmitting the report message is proposed. However, in this case, a problem of link budget deterioration which may be caused upon the increase in the data transmission speed.

FIG. 9B illustrates a signal ranging distance based on a link budget of a data transmission speed according to an embodiment of the disclosure.

Referring to FIG. 9A, when two time stamps need to be transmitted or higher-layer data transmission is additionally required, a case where a report transmission length exceeds a slot length may occur according to a data transmission speed. That is, in the NB channel, a report can be transmitted within 1 ms of one slot through 500 kbps or 1 Mbps, but two or more slots are required in a case of 250 kbps.

In this case, in the NB channel, a method for transmitting the poll and response message at 250 kbps and transmitting the report message at 500 kbps may be proposed. However, to increase the transmission speed, a bandwidth of a data signal is further widened, which may increase possibility of conflict with other wireless technologies or other signals and increase use power, and a link budget may deteriorate.

Accordingly, when the report message is transmitted at 500 kbps, the link budget deteriorates and a signal transmission distance is shortened, and therefore, ranging is performed through poll/response and UWB packet accumulation, but a problem that the report fails to be received may occur.

Referring to FIG. 9B, it may be identified that compared to a transition distance 950 of a poll and response message transmitted at 250 kbps and a UWB MMS fragment transmitted through UWB communication, there is reduction in a transmission distance 955 of a report message transmitted at 500 kbps.

Accordingly, in the disclosure, proposed is a method for transmitting a report message in a UWB channel rather than 500 kbps when a link budget in a case of transmission at 500 kbps is compared with a link budget in a case of transmission of a UWB MSS fragment in the NB channel and the link budget in the case of transmission at 500 kbps in the NB channel is lower.

For example, when a link budget in a case of transmission at 250 kbps in the NB channel at 14 dBm of transmission power is 115.22 dB, a link budget in a case of transmission at 500 kbps in the NB channel is reduced to 112.21 dB, and link budgets in cases of transmission of a UWB MMS fragment one time, four times, and eight times are 99.428 dB, 105.45 dB, and 108.46 dB, respectively, all of the link budgets are equal to or less than 112.21 dB, and thus the report message can be transmitted at 500 kbps in the NB channel.

On the other hand, in consideration of fading due to multipath, only the link budget in the NB channel is reduced, and the link budget in the UWB channel is not reduced. In this case, the link budget in the case of transmission at 250 kbps in the NB channel is 101.22 dB and the link budget in the case of transmission at 500 kbps in the NB channel is reduced to 98.21 dB. Accordingly, the link budget in the case of transmission at 500 kbps in the NB channel is less than the link budgets (99.428 dB, 105.45 dB, and 108.46 dB) in the case of transmission of the UWB MMS fragment one time, four times, and eight times, and thus 500 kbps cannot be used.

Upon the current regulation, the transmission power in the NB channel of the 2.5 MHz channel band is allowed as 14 dBm (25 mW), but there is a case where transmission power in the case of frequency hopping spread spectrum (FHSS) such as BLE is limited to 5 dBm (3 mW). In this case, in the NB channel, the link budget is reduced due to transmission power deterioration, 500 kbps of the NB channel may not be used when additionally transmitting the report message.

For example, when a link budget in a case of transmission at 250 kbps in the NB channel at 5 dBm of transmission power is 106.22 dB, a link budget in a case of transmission at 500 kbps in the NB channel is reduced to 103.21 dB, and link budgets in cases of transmission of a UWB MMS fragment one time, four times, and eight times are 99.428 dB, 105.45 dB, and 108.46 dB, respectively, 500 kbps of the NB channel can be used when the UWB MMS fragment having the link budget of 103.21 dB or less is transmitted one time, and 500 kbps of the NB channel cannot be used when the UWB MMS fragment is transmitted four times and eight times.

Accordingly, when 500 kbps cannot be used due to link budget deterioration at 500 kbps in the NB channel during transmission of the report message, transmission may be performed by utilizing a UWB low rate. Specifically, when transmission is performed by utilizing the low rate in the UWB channel, it is advantageous in use in that it is robust to fading and there is no fading loss in a case of the multipath.

Accordingly, in the disclosure, selecting a transmission carrier (i.e., a transmission band) of the report message may be based on a link budget expected according to the number of UWB fragments, that is, the number of accumulated UWB packets. That is, the report message may be transmitted at 500 kbps in the NB channel only in the case of the number of times of UWB fragment transmission having a link budget less than the link budget in the case of transmission at 500 kbps in the NB channel.

In an embodiment, it is assumed that when a link budget in a case of transmission at 250 kbps in the NB channel at 5 dBm of transmission power is 106.22 dB and a link budget in a case of transmission at 500 kbps in the NB channel is reduced to 103.21 dB, link budgets in cases of transmission of a UWB MMS fragment one time, two times, and third times are 99.428 dB, 102.44 dB, and 104.2 dB, respectively. In this case, the report message may be transmitted at low rate (1.95 Mbps) in the UWB channel only when the UWB MMS fragment having the link budget greater than 103.21 dB is transmitted three times, and the report message may be transmitted at 500 kbps in the NB channel when the UWB MMS fragment having the link budget less than 103.21 dB is transmitted one time and two times.

In an embodiment, in consideration of multipath fading, it is assumed that when a link budget in a case of transmission at 250 kbps in the NB channel at 5 dBm of transmission power is 99.221 dB and a link budget in a case of transmission at 500 kbps in the NB channel is reduced to 89.21 dB, link budgets in cases of transmission of a UWB MMS fragment one time, two times, and three times are 99.428 dB, 102.44 dB, and 104.2 dB, respectively. In this case, the link budgets in cases of transmission of the UWB MMS fragment one time, two times, and three times is greater than 89.21 dB corresponding to the link budget in the case of transmission at 500 kbps in the NB channel, and thus transmission is unconditionally transmitted at a UWB low rate.

Accordingly, an initiator or a responder for performing UWB ranging may determine the number of UWB fragments as described in FIG. 7B according to a channel state, and may determine, as one of the NB channel and the UWB channel, a channel in which the report message is to be transmitted as above in consideration of the link budget according to the number of UWB fragments. In an embodiment, when the initiator determines a channel in which the report message is to be transmitted, the initiator may include configuration information in an advertisement SoR message and transmit the same to the responder. In an embodiment, when the responder determines a channel in which a report message is to be transmitted, the responder may include configuration information in an advertisement response message and transmit the same to the initiator.

Accordingly, when the report message is transmitted at the low rate (1.95 Mbps) in the UWB channel, the transmission length is within a 1-ms slot size and the link budget can be also satisfied.

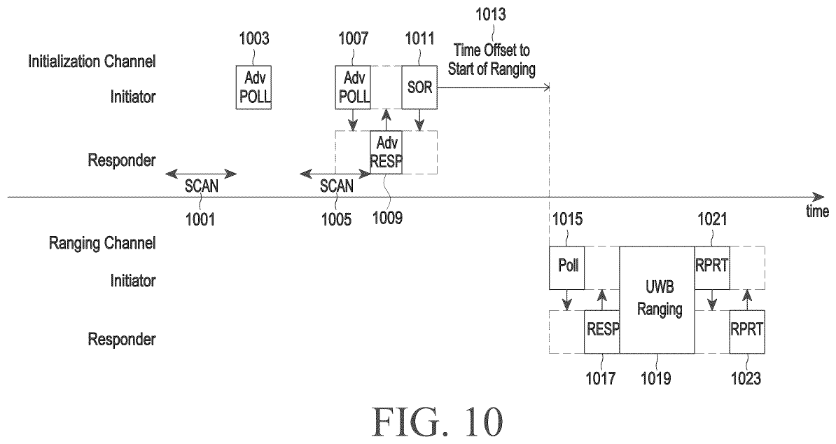

FIG. 10 is a view illustrating operations of an initiator and a responder according to an embodiment of the disclosure.

Referring to FIG. 10, an initiator may be a device for initiating ranging exchange, and may be device for responding to the initiator during the ranging exchange. An initialization channel may be implemented within an NB channel. For example, the initialization channel may be implemented as a discovery channel or a coordination channel implemented in an NB channel. A ranging channel may be implemented as a channel for ranging, which is included in a UWB channel and/or an NB channel.

In operation 1001, the responder may scan an advertisement poll message within a time interval configured in the initialization channel and may fail to receive the advertisement poll message. In operation 1003, the initiator may transmit (or broadcast) the advertisement poll message in the initialization channel. According to an embodiment, the advertisement poll message may be a message (or beacon) for discovery, which is transmitted (or broadcasted) by a controller and/or the initiator.

In operation 1005, the responder may scan an advertisement poll message within a time interval configured in the initialization channel. In operation 1007, upon a result of the scanning, the responder may receive the advertisement poll message transmitted by the initiator. In operation 1009, in the initialization channel, the responder may transmit an advertisement response message corresponding to the advertisement poll message to the initiator. According to an embodiment, the advertisement response message may be a connection response of the responder responding to the advertisement poll message.

In operation 1011, the initiator may transmit a start of ranging (SoR) message corresponding to the advertisement response message to the responder within the initialization channel.

In operation 1013, the initiator may configure and/or apply a time offset for ranging initiation within the initialization channel. The time offset may be a time offset until the initiator and the responder initiate ranging within a ranging channel.

In operation 1015, the initiator may transmit a poll message for ranging to the responder within the ranging channel. In operation 1017, the responder may transmit a response message responding to the poll message to the initiator within the ranging channel. According to an embodiment, the ranging channel in which the poll message and the response message are transmitted or received may be implemented within the NB channel.

In operation 1019, the initiator and the responder may perform UWB ranging within the ranging channel. According to an embodiment, the ranging channel in which the UWB ranging is performed may be implemented within the UWB channel.

In operation 1021, the initiator may transmit report (RPRT) information of the initiator to the responder within the ranging channel. In operation 1023, the responder may transmit report (RPRT) information of the responder to the initiator within the ranging channel. According to an embodiment, the ranging channel in which the RPRT information is transmitted or received may be implemented within the NB channel or the UWB channel.

The operations 1011 and 1013 are initial setup operations for UWB ranging of operations 1015 to 1023, and a channel (i.e., carrier) of report transmission and a data transmission rate may be determined by utilizing a message (or packet) in a discovery process of the initial setup operations. According to an embodiment, the initiator and the responder may exchange a parameter, or the like for an operation of a UWB ranging channel through the advertisement response message and the start of ranging (SoR) message. For example, the parameter for the operation in the UWB ranging channel may include information on a start point of a ranging round, information on a channel occupancy time (e.g., information on a channel occupancy time represented by a multiple time unit (TU)), information on the length of a ranging block, information on the length of the ranging round, the number of times of UWB fragment transmission, a channel (i.e., carrier) of report transmission, a data transmission rate, etc.

In an embodiment, in operation 1007, the advertisement poll message transmitted by the initiator may include the following PSDU structure (12 octet).
1-octet message ID (0x20)
3-octet private address+3-byte private salt
1-octed message control, setting the following message content

0x00: MessageContent=Len[SupportedSetupVersionList] and SupportedSetupVersionList=[0x01]
2-octet CRC16

In an embodiment, in operation 1009, the advertisement response message transmitted by the responder may include the following PSDU structure (21 octet).
1-octet message ID (0x21)
3-octet private address (PrivateSalt known from ADV-POLL)
1-octed message control, setting the following message content

0x01 (Setup Request): MessageContent=[NBChannelSelect[2]+UWBPhyCfg[2]+UWBMACfg[2]+NBPHYCfg[1]+NBMACCfg[8]
2-octet CRC16

In an embodiment, in operation 1011, the SoR message transmitted by the initiator may include the following PSDU structure (24 octet).
1-octet message ID (0x22)
3-octet private address (PrivateSalt known from ADV-POLL)
1-octed message control, setting the following message content

0x01 (Setup): same fields as ADV-RESP, but prepended by TimeOffset[2] and ChannelSeed[l]
2-octet CRC16

A message control field of the SoR message may be identical to a message control field of the advertisement response message, and TimeOffset and ChannelSeed[l] may be added.

The time offset may indicate the length of a start point of a first ranging block from termination of the SoR, and may be one of 0 to 65535 μs. The channel seed refers to a field initiating a channel switching function.

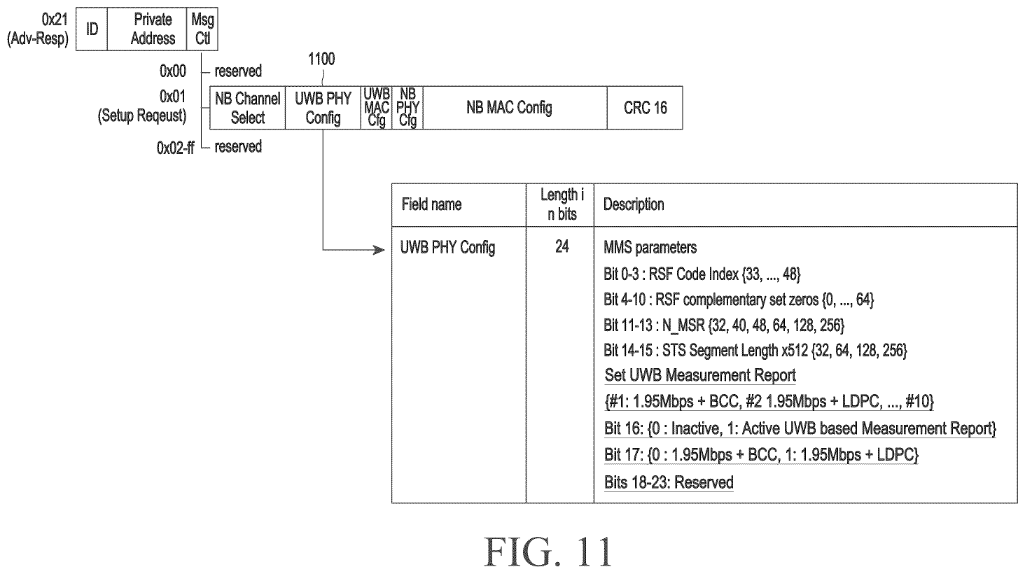

FIG. 11 illustrates an example of a field included in an advertisement response message (or a start of ranging (SoR) message) according to an embodiment of the disclosure.

As described in FIGS. 9A and 9B, FIG. 11 illustrates that in a case where one of the NB channel and the UWB channel is transmitted in consideration of a link budget when a report message is transmitted after UWB ranging in UWB communication, an advertisement response message or a start of ranging (SoR) message includes configuration information of the NB channel or the UWB channel.

In an embodiment, when a responder determines a channel in which a report message is to be transmitted, the responder may include configuration information in an advertisement response message and transmit the same to an initiator. In another embodiment, when the initiator determines a channel in which the report message is to be transmitted, the initiator may include configuration information in an advertisement SoR message and transmit the same to the responder.

FIG. 11 illustrates only the structure of the advertisement response message, and as illustrated in FIG. 10, the same description below may be applied to the start of ranging (SoR) message having the same message control field.

Referring to FIG. 11, the advertisement response message may include a UWB PHY config field 1100 within the message control field, and configure a UWB measurement report within the UWB PHY config field 1100. In an embodiment, a parameter for the UWB measurement report may be configured in eight bits of bits 16 to 23 within the UWB PHY config field 1100. In an embodiment, whether to activate a UWB-based measurement report may be indicated using bit 16 within the UWB PHY config field 1100. For example, when the field is “0”, UWB-based measurement report deactivation may be indicated, and when the field is “1”, UWB-based measurement report activation may be indicated. In an embodiment, a data rate may be indicated together with a channel coding scheme by using bit 17 within the UWB PHY config field 1100. For example, when the field is “0”, a binary convolutional code (BCC) scheme may be indicated at 1.96 Mbps, and when the field is “1”, a low-density parity-check code (LDPC) scheme may be indicated at 1.96 Mbps.

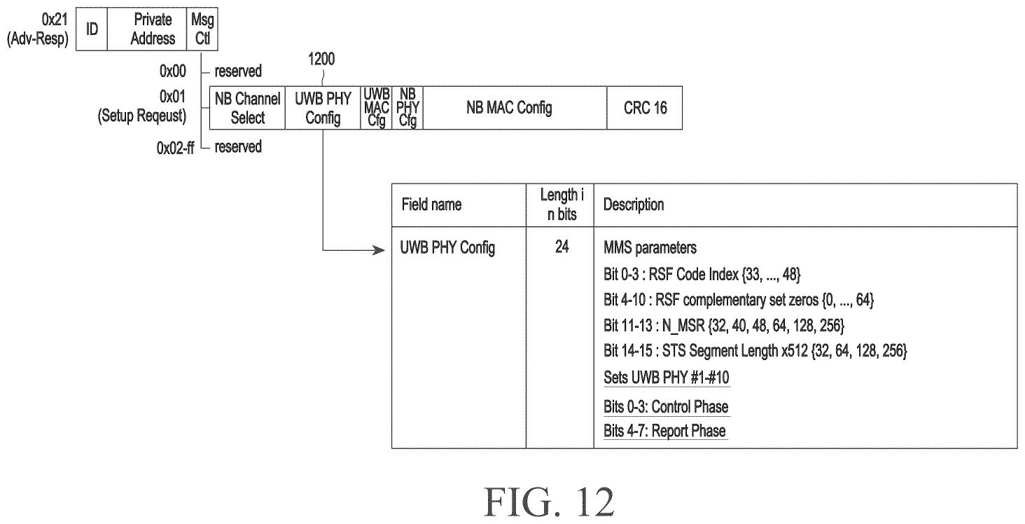

FIG. 12 illustrates an example of a field including an advertisement response message (or a start of ranging (SoR) message) according to an embodiment of the disclosure.

As described in FIGS. 9A and 9B, FIG. 12 illustrates that in a case where one of the NB channel and the UWB channel is transmitted in consideration of a link budget when a report message is transmitted after UWB ranging in UWB communication, an advertisement response message or a start of ranging (SoR) message includes configuration information of the NB channel or the UWB channel.

In an embodiment, when a responder determines a channel in which a report message is to be transmitted, the responder may include configuration information in an advertisement response message and transmit the same to an initiator. In another embodiment, when the initiator determines a channel in which the report message is to be transmitted, the initiator may include configuration information in an advertisement SoR message and transmit the same to the responder.

FIG. 12 illustrates only the structure of the advertisement response message, and as illustrated in FIG. 10, the same description below may be applied to the start of ranging (SoR) message having the same message control field.

Referring to FIG. 12, the advertisement response message may include a UWB PHY config field 1200 within a message control field, and UWB PHY may be mapped for each interval, similar to NB PHY config within the UWB PHY config field 1200. In an embodiment, a PDSD bit rate, a PSDU encoding scheme, a PHR bit rate, and a PHR encoding scheme shown in Table 1 below may be indicated using eight bits of bits 0 to 7 within the UWB PHY config field 1100.

TABLE 1

| | | PHR bit | |
|---|---|---|---|
| PSDU bit rate | | rate | PHR |
| (Mb/s) | PSDU encoding | (Mb/s) | encoding |
| 1.95(4ab) | K = 7 CC | 1.95 | K = 7 CC |
| 6.8 | Reed-Solomon and K = 3 CC | 3.9 | K = 3 CC |
| 7.8 | K = 7 CC | 7.8 | K = 7 CC |
| 27.2 | Reed-Solomon and K = 3 CC | 15.6 | K = 3 CC |
| 31.2 | K = 7 CC | 31.2 | K = 7 CC |
| 62.4(4ab) | K = 7 CC | 62.4 | K = 7 CC |
| 124.8(4ab) | K = 7 CC | 124.8 | K = 7 CC |

Selectively, whether LDPC is enabled, shown in Table 2 below, may be indicated or Tables 1 and 2 may be indicated together using eight bits of bits 0 to 7 within the UWB PHY config field 1100.

TABLE 2

| LDPC enabled | PHR2 bit rate (Mb/s) | PSDU bit rate (Mb/s) |
|---|---|---|
| Yes | 0.975 | 1.95 |
| No | 1.95 | 1.95 |
| Yes | 3.9 | 7.8 |
| No | 7.8 | 7.8 |
| Yes | 15.6 | 31.2 |
| No | 31.2 | 31.2 |
| Yes | 31.2 | 62.4 |
| No | 62.4 | 62.4 |
| Yes | 62.4 | 124.8 |
| No | 124.8 | 124.8 |

Tables 1 and 2 relate to a dynamic PHR code, and the dynamic PHR code may be defined in IEEE 802.15.4ab, and PHR may be divided into PHR 1 and PHR 2. PHR 1 may encode a data transmission rate for the PSDU and whether LDPC coding is used for the PSDU as shown in Table 3 below. In Table 3, a data rate field of PHR 1 indicates a data rate of a received PHY payload field. An LDPC indication field of PHR 1 displays whether to apply LDPC encoding. The contents of PHR 1 determine modulation of PHR 2.

TABLE 3

| Data Rate (Mb/s) | LDPC (Yes/No) | Bit Sequence (20 bits) |
|---|---|---|
| 1.95 | Yes | 11111111111111111111 |
| 1.95 | No | 00000100110011001100 |
| 7.8 | Yes | 00000001100110011001 |
| 7.8 | No | 00000111000011110000 |
| 31.2 | Yes | 00000010010110100101 |
| 31.2 | No | 00000100001111000011 |
| 62.4 | Yes | 00000001011010010110 |
| 62.4 | No | 00000111111100000000 |
| 124.8 | Yes | 00000010101001010101 |
| 124.8 | No | 00000100110000110011 |
| Reserved | Reserved | 11111000000000000000 |
| Reserved | Reserved | 00000001100101100110 |
| Reserved | Reserved | 00000111000000001111 |
| Reserved | Reserved | 00000010010101011010 |
| Reserved | Reserved | 00000100001100111100 |
| Reserved | Reserved | 00000001011001101001 |

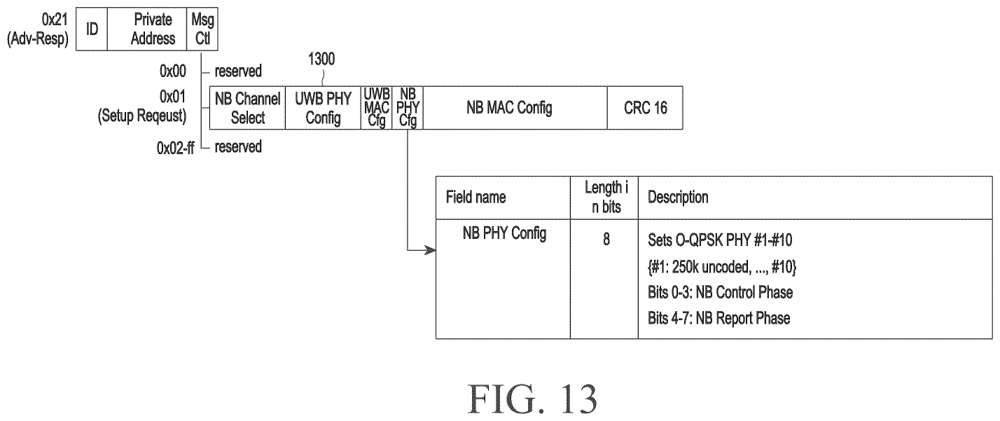

FIG. 13 illustrates an example of a field included in an advertisement response message or a start of ranging (SoR) message according to an embodiment of the disclosure.

As described in FIGS. 9A and 9B, FIG. 13 illustrates that in a case where one of the NB channel and the UWB channel is transmitted in consideration of a link budget when a report message is transmitted after UWB ranging in UWB communication, an advertisement response message or a start of ranging (SoR) message includes configuration information of the NB channel or the UWB channel.

In an embodiment, when a responder determines a channel in which a report message is to be transmitted, the responder may include configuration information in an advertisement response message and transmit the same to an initiator. In another embodiment, when the initiator determines a channel in which the report message is to be transmitted, the initiator may include configuration information in an advertisement SoR message and transmit the same to the responder.

FIG. 13 illustrates only the structure of the advertisement response message, and as illustrated in FIG. 10, the same description below may be applied to the start of ranging (SoR) message having the same message control field.

Referring to FIG. 13, the advertisement response message may include an NB PHY config field 1300 within a message control field, select a meaningless value among NB report phase values of the NB PHY config field 1300, and thus indicate deactivation of NB transmission. In an embodiment, when the deactivation of the NB transmission is indicated, activation of UWB transmission may be pre-configured. For example, when bits 4 to 7 of the NB PHY config field 1300 indicates a value not mapped to NB PHY such as “000”, “111”, and “001”, utilization of UWB transmission may be indicated through deactivation of NB transmission. In an embodiment, when bits 4 to 7 of the NB PHY config field 1300 indicate a value not mapped to NB PHY such as “000”, “111”, and “001”, it may be pre-configured that a data rate is displayed in PHR 1 by utilizing a dynamic PHR mode, or a report message is to be transmitted at UWB 1.95 Mbps at which a link budget is expected to be higher than NB 250 kbps.

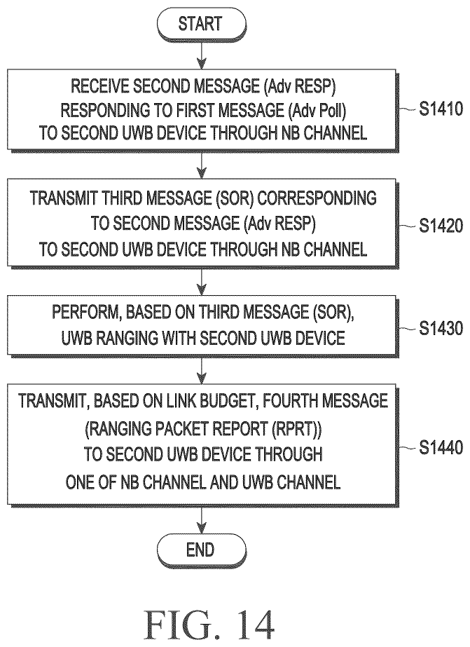

FIG. 14 is a flow chart illustrating an operation of a UWB device according to an embodiment of the disclosure.

FIG. 14 may illustrate an operation of the initiator illustrated in FIG. 10 among UWB devices.

Referring to FIG. 14, in operation S1410, an initiator may receive a second message (e.g., an advertisement response (Adv RESP) message) responding to a first message (e.g., an advertisement poll (Adv Poll) message) from a second UWB device through an NB channel.

In operation S1420, the initiator may transmit a third message (e.g., a start of ranging (SoR) message) corresponding to the second message (e.g., Adv RESP message) to the second UWB device through the NB channel. In an embodiment, the initiator may determine, based on a link budget between the first UWB device and the second UWB device, a channel in which a fourth message (e.g., a ranging packet report (RPRT) message) is to be transmitted. In an embodiment, configuration of a channel in which a fourth message (e.g., a ranging packet report (RPRT) message) is to be transmitted may be included in the third message (e.g., SoR message) and transmitted. In an embodiment, the initiator may compare a first link budget in the NB channel with a second link budget according to a packet transmission count during packet transmission in an MMS scheme in a UWB channel, and determine a channel in which the fourth message (e.g., RPRT message) is to be transmitted by selecting, as the UWB channel, the channel in which the fourth message is to be transmitted in a case that the second link budget is greater than the first link budget.

In an embodiment, the configuration information may be one of indicating deactivation of NB transmission in an NB PHY configuration field within the third message (e.g., SoR message), indicating whether a UWB-based RPRT is activated in a UWB PHY configuration field within the third message (e.g., SoR message), or indicating a data rate in the UWB PHY configuration field within the third message (e.g., SoR message).

In operation S1430, the initiator may perform, based on the third message (e.g., SoR message), UWB ranging with the second UWB device.

In operation S1440, the initiator may transmit, based on a link budget, a fourth message (e.g., RPRT message) to the second UWB device through one of the NB channel or a UWB channel. In an embodiment, when the fourth message may be transmitted in the NB channel, the first message and the second message are transmitted on a first carrier of the NB channel, the fourth message may be transmitted on a second carrier of the NB channel, and the first carrier and the second carrier may be different from each other.

In an embodiment, the second message (e.g., Adv RESP message) may include configuration of a channel in which the fourth message (e.g., RPRT message) determined based on the link budget between the first UWB device and the second UWB device is to be transmitted. In an embodiment, the configuration information may be one of indicating deactivation of NB transmission in an NB PHY configuration field within the second message (e.g., Adv RESP message), indicating whether a UWB-based RPRT is activated in a UWB PHY configuration field within the second message (e.g., Adv RESP message), or indicating a data rate in the UWB PHY configuration field within the second message (e.g., Adv RESP message).

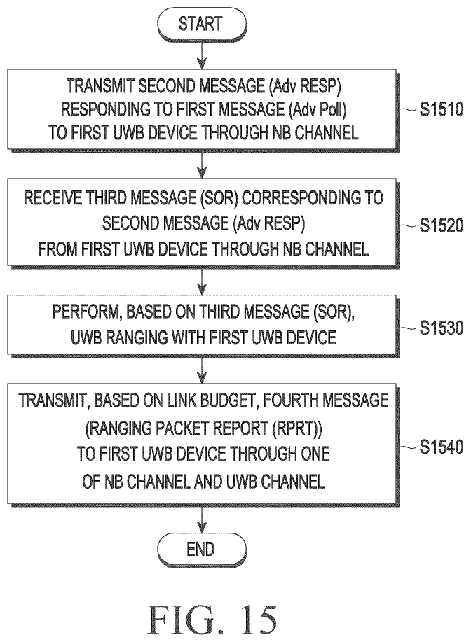

FIG. 15 is a flow chart illustrating an operation of a UWB device according to an embodiment of the disclosure.

FIG. 15 may illustrate an operation of the responder illustrated in FIG. 10 among UWB devices.

In an embodiment, in operation S1510, a responder may transmit a second message (e.g., Adv RESP message) responding to a first message (e.g., Adv Poll message) to a first UWB device through an NB channel. In an embodiment, the responder may determine, based on a link budget between the first UWB device and a second UWB device, a channel in which a fourth message is to be transmitted, and include configuration information of the determined channel in the second message (e.g., Adv RESP message) and transmit the same.

In an embodiment, the configuration information may be one of indicating deactivation of NB transmission in an NB PHY configuration field within the second message (e.g., Adv RESP message), indicating whether a UWB-based RPRT is activated in a UWB PHY configuration field within the second message (e.g., Adv RESP message), or indicating a data rate in the UWB PHY configuration field within the second message (e.g., Adv RESP message).

In operation S1520, the responder may receive a third message (e.g., SoR message) corresponding to the second message (e.g., Adv RESP message) from the first UWB device through the NB channel. In an embodiment, the third message (e.g., SoR message) may include configuration information of a channel in which the fourth message (e.g., RPRT message) determined based on the link budget between the first UWB device and the second UWB device is to be transmitted. In an embodiment, the configuration information may be one of indicating deactivation of NB transmission in an NB PHY configuration field within the third message (e.g., SoR message), indicating whether a UWB-based RPRT is activated in a UWB PHY configuration field within the third message, or indicating a data rate in the UWB PHY configuration field within the third message (e.g., SoR message).

In operation S1530, the responder may perform based on the third message (e.g., SoR message), UWB ranging with the first UWB device.

In operation S1540, the responder may transmit, to the second UWB device, a fourth message (e.g., RPRT message) through one of the NB channel and a UWB channel. In an embodiment, the responder may transmit, based on the link budget, a fourth message (e.g., RPRT message) to the first UWB device through one of the NB channel and a UWB channel. In an embodiment, the channel in which the fourth message (e.g., RPRT message) is to be transmitted may be determined as a UWB channel in case that a first link budget in the NB channel is compared with a second link budge during packet transmission in an MMS scheme in the UWB channel and the second link budget is greater than the first link budget.

In an embodiment, when the fourth message is transmitted in the NB channel, the first message and the second message may be transmitted on a first carrier of the NB channel, the fourth message may be transmitted on a second carrier of the NB channel, and the first carrier and the second carrier may be different from each other.

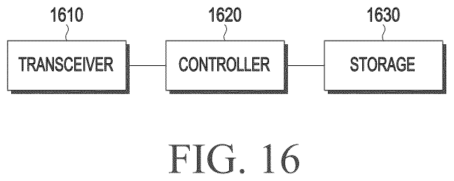

FIG. 16 illustrates a structure of a UWB device according to an embodiment of the disclosure.

In an embodiment of FIG. 16, a UWB device may corresponding to the UWB device illustrated in FIGS. 1A, 1B, 2 to 5, 6A, 6B, 7A, 7B, 8A, 8B, 9A, 9B, and 10 to 15, or may be an electronic device including a UWB device or a part of the UWB device.

In an embodiment of FIG. 16, the UWB device may be a UWB device for performing the role of an initiator and/or a controller. In another embodiment, the UWB device may be a UWB deice for performing the role of a responder and/or a controlee.

Referring to FIG. 16, the UWB device may include a transceiver 1610, a controller 120, and a storage 1630. The control unit in the disclosure may be defined as a circuit, an application-specific integrated circuit, or at least one processor.

The transceiver 1610 may transmit or receive a signal with another entity. The transceiver 1610 may transmit data to or from another device by using, for example, at least one NB channel and/or at least one UWB channel.

In an embodiment, the transceiver 1610 may include at least one first transceiver supporting the NB channel and at least one second transceiver supporting the UWB channel. In another embodiment, the transceiver 1610 may include at least one transceiver supporting the NB channel and the UWB channel together.

The controller 1620 may control an overall operation of an electronic device according to an embodiment proposed in the disclosure. For example, the controller 1620 may control a signal flow between respective blocks to perform an operation according to the flow chart described above. Specifically, for example, the controller 1620 may control an operation of the UWB device described with reference to FIGS. 1A, 1B, 2 to 5, 6A, 6B, 7A, 7B, 8A, 8B, 9A, 9B, and 10 to 15.

The storage 1630 may store at least one of information transmitted or received through the transceiver 1610 and information generated through the controller 1620. For example, for example, the storage 1630 may store information and data required for the method described with reference to FIGS. 1A, 1B, 2 to 5, 6A, 6B, 7A, 7B, 8A, 8B, 9A, 9B, and 10 to 15.

According to an embodiment, the controller 1620 may be configured to receive an advertisement response (Adv RESP) message responding to an advertisement poll (Adv Poll) message from a second UWB device through an NB channel, transmit a start of ranging (SoR) message corresponding to the Adv RESP message to the second UWB device through the NB channel, perform based on the SoR message, UWB ranging with the second UWB device, and transmit a ranging packet report (RPRT) message to the second UWB device. According to an embodiment, the RPRT message may be transmitted based on the link budget between the first UWB device and the second UWB device through one of the NB channel and a UWB channel.

According to an embodiment, the controller 1620 may be configured to determine, based on the link budget between the first UWB device and the second UWB device, a channel in which the RPRT message is to be transmitted, and the SoR message may include configuration of the determined channel.

According to an embodiment, the controller 1620 may be further configured to compare a first link budget in the NB channel with a second link budget according to a packet transmission count during packet transmission in an MMS scheme in a UWB channel, and select, as the UWB channel, the channel in which the RPRT message is to be transmitted in case that the second link budget is greater than the first link budget.

According to an embodiment, the controller 1620 may be configured to transmit an Adv RESP message responding to an Adv Poll message to a first UWB device through an NB channel, receive an SoR message corresponding to the second message from the first UWB device through the NB channel, perform, based on the SoR message, UWB ranging with the first UWB device, and transmit an RPRT message to the first UWB device.

According to an embodiment, the RPRT message may be transmitted based on the link budget between the first UWB device and the second UWB device through one of the NB channel and a UWB channel.

According to an embodiment, the controller 1620 may be configured to determine, based on the link budget between the first UWB device and the second UWB device, a channel in which the RPRT message is to be transmitted. According to an embodiment, the Adv RESP message may include configuration information of the determined channel.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first ultra-wideband (UWB) device, the method comprising:
receiving, from a second UWB device, an advertisement response (Adv RESP) message responding to an advertisement poll (Adv Poll) message through a narrow band (NB) channel;
transmitting, to the second UWB device, a start of ranging (SoR) message corresponding to the Adv RESP message through the NB channel;
performing, based on the SoR message, UWB ranging with the second UWB device; and
transmitting, to the second UWB device, a ranging packet report (RPRT) message through one of the NB channel and a UWB channel based on configuration information for a channel in which the RPRT message is to be transmitted,
wherein the configuration information is included in the SoR message.

2. The method of claim 1, further comprising:
determining, based on a link budget between the first UWB device and the second UWB device, the channel in which the RPRT message is to be transmitted,
wherein the determining of the channel in which the RPRT message is to be transmitted includes:
comparing a first link budget in the NB channel with a second link budget according to a packet transmission count during packet transmission in a multi-millisecond (MMS) scheme in the UWB channel; and
in case that the second link budget is greater than the first link budget, selecting the UWB channel, as the channel in which the RPRT message is to be transmitted.

3. The method of claim 1, wherein in case that the RPRT message is transmitted in the NB channel:
the Adv Poll message and the Adv RESP message are transmitted on a first carrier of the NB channel; and
the RPRT message is transmitted on a second carrier of the NB channel.

4. The method of claim 1, wherein the configuration information indicates deactivation of NB transmission within the SoR message.

5. The method of claim 1, wherein the configuration information indicates at least one of:
whether a UWB-based RPRT is activated in a UWB physical (PHY) configuration field within the SoR message, or
a data rate in a UWB PHY configuration field within the SoR message.

6. The method of claim 1, wherein the Adv RESP message includes second configuration information of a channel in which an RPRT message is to be transmitted by the second UWB device.

7. The method of claim 6, wherein the second configuration information indicates at least one of:
deactivation of NB transmission within the Adv RESP message,
whether a UWB-based RPRT is activated in a UWB physical (PHY) configuration field within the Adv RESP message, or
a data rate in the UWB PHY configuration field within the Adv RESP message.

8. A method performed by a second ultra-wideband (UWB) device, the method comprising:
transmitting, to a first UWB device, an advertisement response (Adv RESP) message responding to an advertisement poll (Adv Poll) message through a narrow band (NB) channel;
receiving, from the first UWB device, a start of ranging (SoR) message corresponding to the Adv RESP message through the NB channel;
performing, based on the SoR message, UWB ranging with the first UWB device; and
transmitting, to the first UWB device, a ranging packet report (RPRT) message through one of the NB channel and a UWB channel based on configuration information for a channel in which the RPRT message is to be transmitted,
wherein the configuration information is included in the Adv RESP message.

9. The method of claim 8, wherein the SoR message includes second configuration information of a channel in which a RPRT message is to be transmitted by the first UWB device.

10. The method of claim 8,
wherein the Adv Poll message and the Adv RESP message are transmitted on a first carrier of the NB channel, and
wherein the RPRT message is transmitted on a second carrier of the NB channel.

11. The method of claim 9, wherein the second configuration information indicates deactivation of NB transmission within the SoR message.

12. The method of claim 9, wherein the second configuration information indicates at least one of:
whether a UWB-based RPRT is activated in a UWB physical (PHY) configuration field within the SoR message, or
a data rate in a UWB PHY configuration field within the SoR message.

13. The method of claim 8, further comprising:
determining, based on a link budget between the first UWB device and the second UWB device, the channel in which the RPRT message is to be transmitted,
wherein the determining of the channel in which the RPRT message is to be transmitted includes:
comparing a first link budget in the NB channel with a second link budget according to a packet transmission count during packet transmission in a multi-millisecond (MMS) scheme in the UWB channel; and
in case that the second link budget is greater than the first link budget, selecting the UWB channel, as the channel in which the RPRT message is to be transmitted.

14. The method of claim 8, wherein the configuration information indicates one of:
deactivation of NB transmission within the Adv RESP message,
whether a UWB-based RPRT is activated in a UWB physical (PHY) configuration field within the Adv RESP message, or
a data rate in the UWB PHY configuration field within the Adv RESP message.

15. A first ultra-wideband (UWB) device comprising:
a transceiver; and
at least one processor coupled to the transceiver and configured to:
receive, from a second UWB device, an advertisement response (Adv RESP) message responding to an advertisement poll (Adv Poll) message through a narrow band (NB) channel;
transmit, to the second UWB device, a start of ranging (SoR) message corresponding to the Adv RESP message through the NB channel;
perform, based on the SoR message, UWB ranging with the second UWB device; and
transmit, to the second UWB device, a ranging packet report (RPRT) message through one of the NB channel and a UWB channel based on configuration information for a channel in which the RPRT message is to be transmitted,
wherein the configuration information is included in the SoR message.

16. The first UWB device of claim 15, wherein the configuration information indicates deactivation of NB transmission within the SoR message.

17. The first UWB device of claim 15,
wherein the Adv RESP message includes second configuration information of a channel in which an RPRT message is to be transmitted by the second UWB device, and
wherein the second configuration information indicates deactivation of NB transmission within the Adv RESP message.

18. A second ultra-wideband (UWB) device comprising:
a transceiver; and
at least one processor coupled to the transceiver and configured to:
transmit, to a first UWB device, an advertisement response (Adv RESP) message responding to an advertisement poll (Adv Poll) message through a narrow band (NB) channel;
receive, from the first UWB device, a start of ranging (SoR) message corresponding to the Adv RESP message through the NB channel;
perform, based on the SoR message, UWB ranging with the first UWB device; and
transmit, to the first UWB device, a ranging packet report (RPRT) message through one of the NB channel and a UWB channel based on configuration information for a channel in which the RPRT message is to be transmitted,
wherein the configuration information is included in the Adv RESP message.

19. The second UWB device of claim 18, wherein the SoR message includes second configuration information of a channel in which a RPRT message is to be transmitted by the first UWB device.

20. The second UWB device of claim 19,
wherein the configuration information indicates deactivation of NB transmission within the Adv RESP message, and
wherein the second configuration information indicates deactivation of NB transmission within the SoR message.
